(19) United States
(12) Patent Application Publication
(10) Pub. No.: US 2009/0061953 A1
(43) Pub. Date: Mar. 5, 2009

(54) MOBILE TERMINAL AND METHOD FOR CONTROLLING POWER THEREOF

(75) Inventor: Hyun Bong JANG, Yongin-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/189,269

(22) Filed: Aug. 11, 2008

(30) Foreign Application Priority Data
Sep. 4, 2007 (KR) 2007-89446

(51) Int. Cl. H04M 1/00

(52) U.S. Cl. 455/572

(57) ABSTRACT

A mobile terminal and a method for controlling power thereof are provided. The method includes determining, if a power on/off key for turning off power is input, whether a quick power off mode is selected, converting, if a quick power off mode is selected, a power mode of a controller and of a storage unit of the mobile terminal into a power save mode and turning off power to components of the mobile terminal other than the controller and storage unit. Accordingly, a user can reduce the time required for turning on and off power of the mobile terminal. Also, the user can control power of the mobile terminal according to circumstances.

### PRIORITY

This application claims the benefit under 35 U.S.C. §119(a) of a Korean patent application filed in the Korean Intellectual Property Office on Sep. 4, 2007 and assigned Serial No. 2007-0089446, the entire disclosure of which is hereby incorporated by reference.

### BACKGROUND OF THE INVENTION

1. Field of the Invention

The present invention relates to a mobile terminal and method of supplying power thereto. More particularly, the present invention relates to a mobile terminal and a method for controlling the powering on and off thereof.

2. Description of the Related Art

Typically, in order to turn off power in a mobile terminal, a power on/off key is input or a battery is detached.

During operation, a mobile terminal performs various functions including the running of control programs that create or alter operating data such as values used for the set up of the terminal. These data and values, including the programs, are stored in a Random Access Memory (RAM) because of its high speed, which makes the information quickly and easily accessible. In the case that power is turned off using the power on/off key in the mobile terminal, a controller moves important set up values and programs for performing functions stored in the RAM to a Read-Only Memory (ROM) and stores the set up values and programs therein. The controller then cuts off power for all components of the mobile terminal and, using a wireless communication unit, informs a base station that power of the mobile terminal is turned off. Because of an internal power-off operation process time, the time required for turning off power using the power on/off key is longer than the time required for turning off power by simply detaching the battery.

In order to turn on power in a mobile terminal, a power on/off key may be input. In a case that power is turned on using the power on/off key in the mobile terminal, a controller moves important set up values and programs for performing a function from the ROM to the RAM. The controller initializes the components of the mobile terminal and restores a state of the mobile terminal to an original set up state using the important set up values and the programs previously moved into the RAM. Thereafter, the controller transmits a signal to a base station through a wireless communication unit to perform communication.

However, since the time required for turning on and off power using the power on/off key in the mobile phone is relatively long, it causes an inconvenience for a user. Also, if the user desires to turn off power of the mobile terminal quickly, for example in the case of an incoming call in a quiet environment, such as a theatre, conference room or library, the long time required to power off the mobile terminal is a further inconvenience.

### SUMMARY OF THE INVENTION

An aspect of the present invention is to address the above-mentioned problems and/or disadvantages and to provide at least the advantages described below. Accordingly, an aspect of the present invention is to provide a method for reducing the time required for turning on and off power in a mobile terminal using a power on/off key.

In accordance with an aspect of the present invention, a method for controlling power of a mobile terminal is provided. The method includes determining, if a power on/off key for turning off power is input, whether a quick power off mode is selected, converting, if a quick power off mode is selected, a power mode of a controller and of a storage unit of the mobile terminal into a power save mode and turning off power to components of the mobile terminal other than the controller and storage unit.

In accordance with another aspect of the present invention, a mobile terminal is provided. The mobile terminal includes a storage unit having a ROM and RAM for storing important set up values and control programs of the mobile terminal, a power supply unit for supplying power to components of the mobile terminal and a controller for controlling the power supply to convert a power supply mode of the controller into a power save mode, to convert a power supply mode of the RAM into a power save mode, and to turn off power to components of the mobile terminal other than the controller and the RAM.

According to the present invention, a time for turning off power of a mobile terminal using a power on/off key can be reduced. Thus, a user can turn off power of the mobile terminal quickly when required, for example, in the case of an incoming call in a quiet environment, such as a theatre, conference room or library. Further, a time for turning on power of the mobile terminal after turning off power of the mobile terminal using the power on/off key can be reduced. Thus, the user can turn on and off power of the mobile terminal conveniently.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description in conjunction with the accompanying drawings, in which:

FIG. 1 is a block diagram illustrating a configuration of a mobile terminal according to an exemplary embodiment of the present invention;

FIG. 2 is a flowchart illustrating a method for turning off power of a mobile terminal according to an exemplary embodiment of the present invention;

FIG. 3 is a flowchart illustrating a process of turning off power according to an exemplary embodiment of the present invention;

FIG. 4 is a flowchart illustrating a method for turning on power of a mobile terminal according to an exemplary embodiment of the present invention; and

FIG. 5 is a flowchart illustrating a process of turning on power according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In exemplary embodiments of the invention as described hereinafter, the term ‘normal power supply mode’ refers to a mode in which power is supplied when performing functions in a mobile terminal. The term ‘power save mode’ refers to a mode in which minimum power is supplied to operate only a required minimum of necessary components. And the term ‘self refresh mode’ refers to a mode in which a process for supplying electricity to maintain data stored in a RAM is performed.

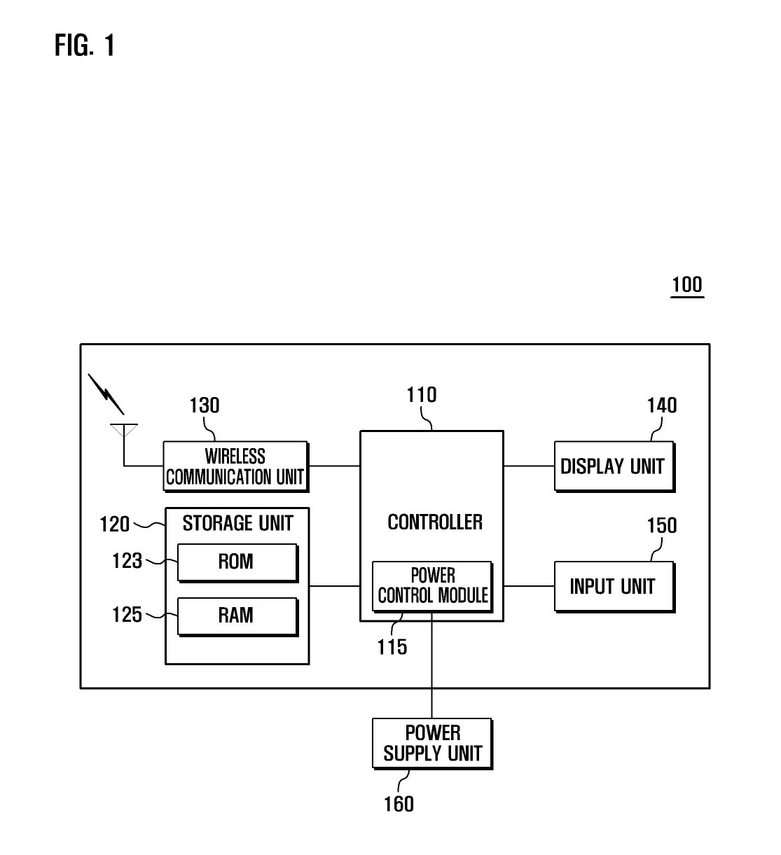

FIG. 1 is a block diagram illustrating a configuration of a mobile terminal according to an exemplary embodiment of the present invention.

Referring to FIG. 1, a mobile terminal 100 includes a controller 110, a storage unit 120, a wireless communication unit 130, a display unit 140, an input unit 150 and a power supply unit 160.

The controller 110 controls the general operation of the mobile terminal 100, such as a communication function. The controller 110 also controls various states or modes of the mobile terminal 100. In the illustrated exemplary embodiment, the controller 110 includes a power control module 115 for controlling power supplied to components of the mobile terminal 100. In particular, in a quick power off mode, the power control module 115 converts a normal power supply mode of the controller 110 into a power save mode, and converts a normal power supply mode of the storage unit 120 into a self refresh mode. Further, in the quick power off mode, the power control module 115 cuts off power supplied to components other than the controller 110 and the storage unit 120. Although the power control module 115 is illustrated in FIG. 1 as being a part of the controller 110, this is merely for example and it is to be understood that the power control module 115 may be provided as a separate component.

In a quick power on mode, the power control module 115 converts the power save mode of the controller 110 into the normal power supply mode, and converts the self refresh mode of the storage unit 120 into the normal power supply mode. Further, the power control module 115 controls the power supply unit 160 to supply power to the other components of the mobile terminal 100.

The storage unit 120 stores a variety of programs for controlling operations of the mobile terminal 100 as well as various data generated during operations of the mobile terminal 100. The storage unit 120 includes a ROM 123 and a RAM 125. The ROM 123 stores a variety of programs for controlling operations of the mobile terminal 100 as well as various data and values used for the control. In an exemplary implementation, a NAND flash memory may be used as the ROM, and data may be stored therein without any power supply. Because of its volatility, the RAM 125 is used for temporary storage. For example, the RAM 125 is temporarily stores data generated during operations of the mobile terminal 100, important set up values, and control programs for performing functions of the mobile terminal. In an exemplary implementation, an SDRAM (Synchronous Dynamic RAM) is used as the RAM in the mobile terminal 100. In the case that power supply is cut off, the control programs, important set up values and other data stored in the RAM 125 are lost. Thus, when the power supply is cut off, the controller 110 moves the programs, important set up values and data temporarily stored in the RAM 125 to the ROM 123 for storage. However, in the quick power off mode, the RAM 123 of the storage unit 120 may perform the self refresh mode and continue to store the control programs, important set up values and data under the control of the controller 110.

The wireless communication unit 130 performs a radio frequency communication function for the mobile terminal 100. For example, using the wireless communication unit 130, the mobile terminal 100 may communicate with a base station. The wireless communication unit 130 may include a duplexer for separating transmission and reception functions, a transmitter for up-converting a frequency of a transmission signal, and a receiver for down-converting a frequency of a received signal. Further, the wireless communication unit 130 may transmit text messages or make a phone call under the control of the controller 110.

The display unit 140 displays a variety of information on operations and states of the mobile terminal 100. The display unit 140 may include an LCD unit. In this case, the display unit 140 may also include an LCD controller, a memory for storing image data, and an LCD display device. Here, if the LCD is embodied as a touch screen type, the LCD may be operated as an input unit, either in place of or in conjunction with the input unit 150. In particular, the display unit 140 displays a window for selecting the quick power off mode under the control of the controller 110. The window may be displayed in a pop-up form or an overlay form.

The input unit 150 includes input keys for inputting characters and function keys for inputting or setting various functions. The function keys may include a directional key, a side key and a shortcut key that are set up to perform specific functions. In particular, the input unit 150 includes a power on/off key to turn power on or off.

The power supply unit 160 supplies power to the components of the mobile terminal 100. In particular, if the quick power off mode is selected, the power supply unit 160 supplies only a minimum required power to the controller 110 and the RAM 125 of the storage unit 120. In this case, under the control of the controller 110, the power supply unit 160 does not supply power to the components other than the controller 110 and the RAM 125 of the storage unit 120.

The mobile terminal 100 may further include various functional components. For example, the mobile terminal 100 may further include a camera unit for a camera function, a Digital Multimedia Broadcasting (DMB) unit for a DMB function, a music player and the like.

In the mobile terminal 100 with the above configuration, if the quick power off mode is selected, the controller 110 controls the power supply unit 160 to convert the normal power supply mode into the power save mode, and to convert the normal power supply mode of the storage unit 120 into the self refresh mode. Then, the controller 110 controls the power supply unit 160 to cut off power being supplied to the other components.

If the quick power on mode is selected, the controller 110 controls the power supply unit 160 to convert the power save mode into the normal power supply mode, and to convert the self refresh mode of the storage unit 120 into the normal power supply mode. Thereafter, the controller 110 controls the power supply unit 160 to supply power to the other components.

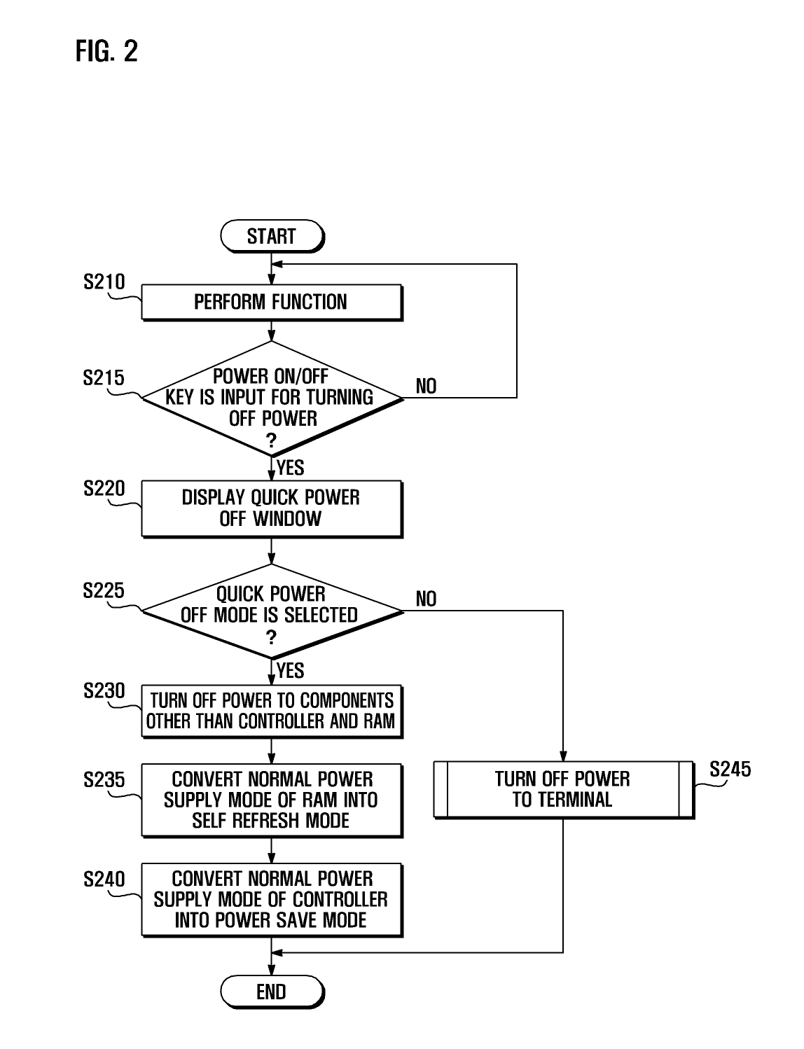

FIG. 2 is a flowchart illustrating a method for turning off power of the mobile terminal 100 according to an exemplary embodiment of the present invention. [00341 Referring to FIG. 2, the mobile terminal 100 performs a function in step 210. The function performed at step S210 may refer to any function to be performed in the mobile terminal 100, for example, a stand-by mode function, a call receiving function, etc. In step 215, the controller 110 determines whether the power on/off key is input for turning off power. More specifically, the power on/off key can be input for ending a function being performed in the mobile terminal 100 or for turning off power of the mobile terminal 100. Typically, the power on/off key is input for a longer time period when it is desired to turn off the power of the mobile terminal 100 than for ending the function. By determining the duration of the input, the power on/off key input for turning off the power can be distinguished from the power on/off key input for ending the function. Accordingly, in step 215 the controller 110 determines whether the power on/off key is input for a relatively long time or a relatively short time, to determine whether the power on/off key input is for turning off the power. The controller 110 may control the time required for turning on and off power of the mobile terminal 100 when the quick power on/off mode is selected. Alternatively, other differences may be used to distinguish using the power on/off key to end a function as compared to using the power on/off key to turn off power to the terminal. For example, a quick succession of multiple inputs of the power on/off key may be used to indicate the turning off of power whereas a single input may be used to indicate the ending of a function.

If the power on/off key is input for turning off power at step S215, the controller 110 displays a quick power off window in the display unit 140 in step S220. Here, the quick power off window may be displayed in the display unit 140 in a popup form or an overlay form. Thereafter, the controller 110 determines whether the quick power off mode is selected in step S225. In an exemplary implementation, the controller 110 may sense that the quick power off mode is selected if a user inputs a directional key for selecting a direction provided in the input unit 150 or if the user inputs the power on/off key for a relatively long time when the quick power off window is being displayed. Of course, if the display unit 140 is implemented having a touch screen, the user may simply touch a part of the touch screen corresponding to a quick power off mode. Further, the quick power off mode may be selected from a preset menu, or alternatively a function key for performing the quick power off mode may be separately set.

If the quick power off mode is selected, the controller 110 controls the power supply unit 160 to turn off power to the components other than the controller 110 and the RAM 125 (for example, the input unit 150, the display unit 140, a camera unit, and the like) of the mobile terminal 100 in step S230. The controller 110 then controls the power supply unit 160 to convert a normal power supply mode of the RAM 125 of the storage unit 120 into a self refresh mode, which is a power save mode of the RAM 125 in step S235. Since the RAM 125 is a volatile memory, data stored in the RAM 125 will be lost if power is not supplied. Thus, the controller 110 converts the power supply mode of the RAM 125 into the self refresh mode so that data, important set up values and control programs stored in the RAM 125 are not lost. In this way, the data, important set up values and control programs remain stored in the RAM 125. Therefore, because time is not used for moving the data, values and programs stored in the RAM 125 to the ROM 123, the necessary duration for turning off power of the mobile terminal 100 is reduced. Thereafter, the controller 110 converts the normal power supply mode into the power save mode in step S240.

If the quick power off mode is not selected at step S225, the controller 110 turns off power in step S245, as described in detail hereinafter.

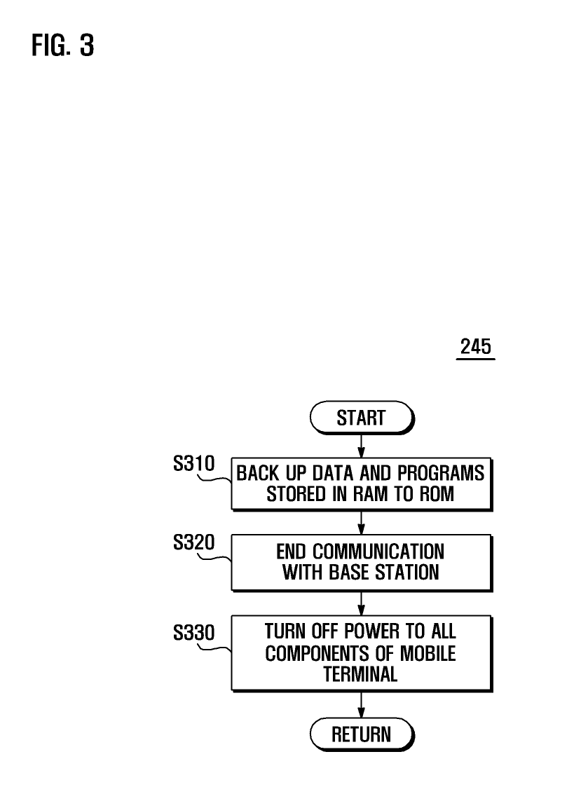

FIG. 3 is a flowchart illustrating a process of step S245 for turning off power according to an exemplary embodiment of the present invention.

Referring to FIG. 3, if the quick power off mode is not selected, the controller 110 backs up data, important set up values, and control programs stored in the RAM 125 to the ROM 123 in step S310. Next, the controller 110 controls the wireless communication unit 130 to transmit a message informing that a power state of the mobile terminal 100 is off to a base station, and then to end communication with the base station in step S320. Then, power to all components of the mobile terminal 100 including the controller 110 is turned off in step S330.

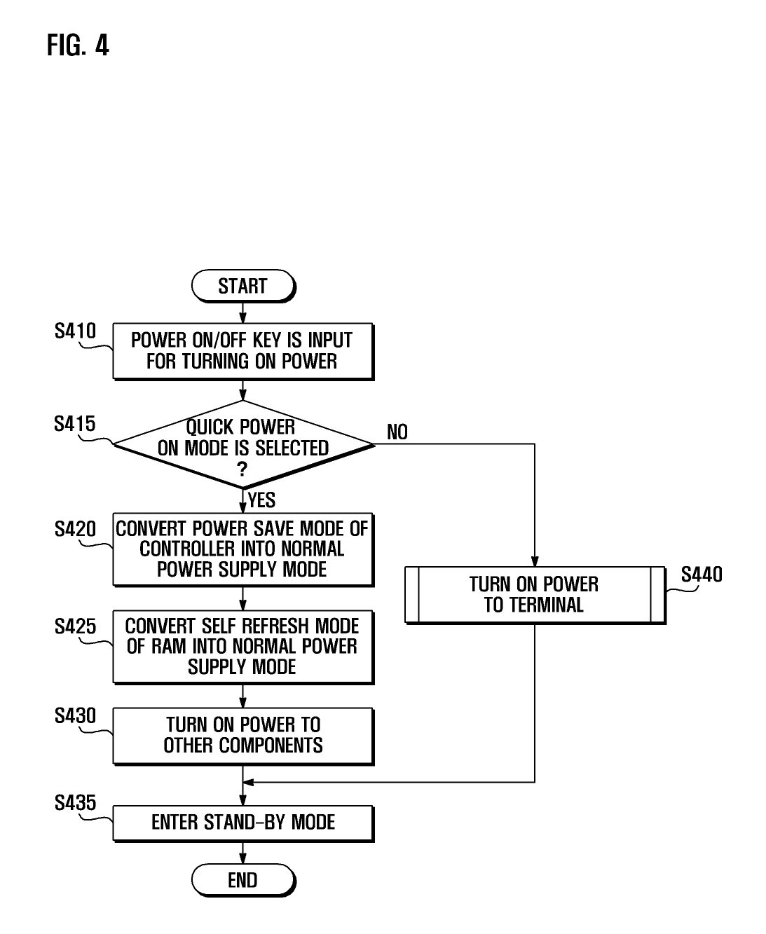

FIG. 4 is a flowchart illustrating a method for turning on power of a mobile terminal 100 according to an exemplary embodiment of the present invention.

Referring to FIG. 4, the controller 110 senses that the power on/off key provided in the input unit 150 is input for a relatively long time to turn on power of the mobile terminal 100 in step S410. As described above regarding the use of the on/off key, the duration of the input for sensing a power on operation may be adjusted. Also, the type of input itself may be altered, for example a series of quick inputs on the on/off key may be used to indicate a power on operation. The controller 110 determines whether the power on mode is the quick power on mode in step S415. That is, the controller 110 determines a power supply mode of the controller 110 and a power supply mode of the RAM 125. If both power supply modes are a power save mode, that is the power save mode of the controller 110 and the self refresh mode of the RAM 125, the controller 110 determines that the power on mode is the quick power on mode.

If the controller 110 determines that the power on mode is the quick power on mode, the controller 110 controls the power supply unit 160 to convert the power save mode into the normal power supply mode in step S420, and to convert the self refresh mode of the RAM 125 into the normal power supply mode in step S425. The controller 110 controls the power supply unit 160 to turn on power to the other components of the mobile terminal 100 in step S430. The controller 110 then displays a stand-by screen on the display unit 140 and enters a stand-by mode in step S435.

If it is determined that the power on mode is not the quick power on mode at step S420, the controller 110 turns on power in step S440, as described in detail hereinafter.

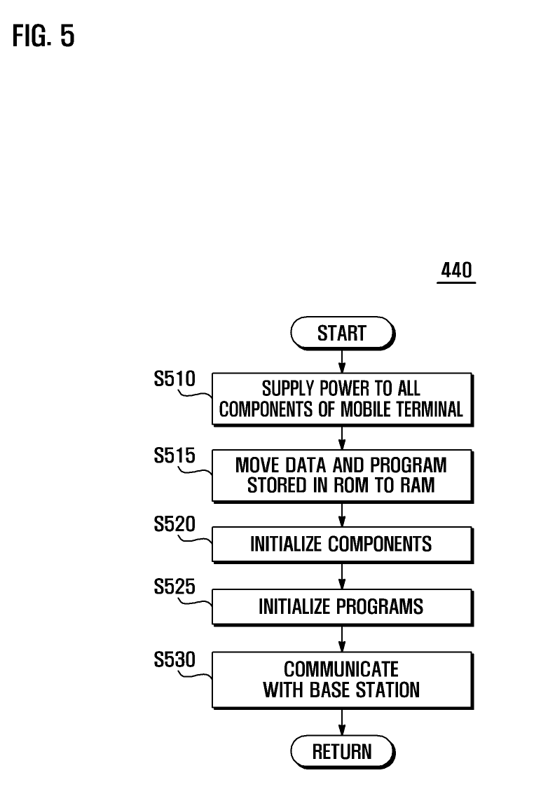

FIG. 5 is a flowchart illustrating the process of step S440 for turning on power according to an exemplary embodiment of the present invention.

Referring to FIG. 5, when the controller 110 determines that the power on/off key input is not for the quick power on mode, the controller 110 controls the power supply unit 160 to supply power to all components provided in the mobile terminal 100 in step S510. Then, the controller 110 moves data, control programs and important set up values stored in the ROM 123 to the RAM 125 for storage in step S515. The controller 110 initializes all components of the portable terminal 100 using a control program stored in the RAM 125 in step S520, and initializes application programs for performing functions of the mobile terminal 100 in step S525. When the initialization is completed, the controller 110 communicates with a base station through the wireless communication unit 130 in step S530.

As described above, according to exemplary embodiments of the present invention, data, important set up values and control programs are stored in the RAM 125 in the quick power on mode, and the controller 110 can thereby omit a process for initializing components of the mobile terminal 100 and application programs for performing functions thereof. By omitting the initialization process, a time for turning on power in the mobile terminal 100 is reduced.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims and their equivalents.

What is claimed is:

1. A method for controlling power of a mobile terminal, the method comprising:
determining, if a power on/off key for turning off power is input, whether a quick power off mode is selected;
converting, if a quick power off mode is selected, a power mode of a controller and of a storage unit of the mobile terminal into a power save mode; and
turning off power to components of the mobile terminal other than the controller and storage unit.

2. The method according to claim 1, wherein the converting of the power mode of the controller and of the storage unit into a power save mode comprises converting a normal power supply mode of the storage unit into a self refresh mode.

3. The method according to claim 2, wherein the storage unit comprises a RAM.

4. The method according to claim 1, further comprising turning off, if a quick power off mode is not selected, power to all components of the mobile terminal.

5. The method according to claim 1, further comprising:
determining, if a power on/off key for turning on power is input, whether a quick power on mode is selected;
converting, if a quick power on mode is selected, a power save mode of the controller and of the storage unit of the mobile terminal into a normal power supply mode; and
turning on power to the components of the mobile terminal other than the controller and storage unit.

6. The method according to claim 5, further comprising turning on, if a quick power on mode is not selected, power to all components of the mobile terminal.

7. A mobile terminal comprising:
a storage unit having a ROM and RAM for storing set up values and control programs of the mobile terminal;
a power supply unit for supplying power to components of the mobile terminal; and
a controller for controlling the power supply to convert a power supply mode of the controller into a power save mode, to convert a power supply mode of the RAM into a power save mode, and to turn off power to components of the mobile terminal other than the controller and the RAM.

8. The mobile terminal according to claim 7, further comprising:
an input unit having a power on/off key; and
a display unit for displaying, if the power on/off key is input for turning off power, a window for selecting a quick power off mode.

9. The mobile terminal according to claim 8, wherein, if the power on/off key is input for turning on power, the controller determines whether a quick power on mode is selected and, if a quick power on mode is selected, controls the power supply to convert the power save mode of the controller and of the storage unit into a normal power supply mode and to turn on power to the components of the mobile terminal other than the controller and the RAM.

10. A method for controlling power of a mobile terminal, the method comprising:
determining if a quick power off mode is selected;
converting a normal power supply mode of a storage unit to a self refresh mode if it is determined that the quick power off mode is selected; and
turning off power to components of the mobile terminal other than the storage unit.

11. The method of claim 10, further comprising converting a normal power supply mode of a control unit to a power save mode if it is determined that the quick power off mode is selected, wherein the turning off of power to components of the mobile terminal includes turning off of power to components other than the storage unit and the control unit.

12. The method of claim 11, further comprising determining if an input is received indicating a power off selection prior to the determining if the quick power off mode is selected.

13. The method of claim 12, wherein the determining if the input is received indicating a power off mode comprises determining if a first long-duration input is received from a power on/off key.

14. The method of claim 13, wherein the determining if the quick power off mode is selected comprises determining if a second long-duration input is received from a power on/off key.

15. The method of claim 13, further comprising:
displaying a menu for selection of the quick power off mode; and
receiving an input corresponding to the menu for the quick power off mode.

16. The method of claim 10, further comprising turning off power to all components if the quick power off mode is not selected.

17. The method of claim 11, further comprising:
determining that a quick power on mode is selected when it is determined that the quick power off mode is selected;
converting the self refresh mode of the storage unit to the normal supply mode;
converting the power save mode of the control unit to the normal supply mode; and
turning on power to components of the mobile terminal other than the storage unit and the control unit.
